(19) United States
(12) Patent Application Publication
(10) Pub. No.: US 2003/0125418 A1
(43) Pub. Date: Jul. 3, 2003

(54) Particulate alumina, method for producing particulate alumina, and composition containing particulate alumina

(75) Inventors: Susumu Shibusawa, Kanagawa (JP); Hidetoshi Okamoto, Kanagawa (JP); Hiroshi Takahashi, Chiba (JP); Nobuo Uotani, Chiba (JP); Koichiro Take, Tochigi (JP)

Correspondence Address: SUGHRUE MION, PLLC, 2100 Pennsylvania Avenue, NW, Washington, DC, 20037-3213, US

(73) Assignee: SHOW A DENKO K.K.

(21) Appl. No.: 10/267,749

(22) Filed: Oct. 10, 2002

Related U.S. Application Data
(60) Provisional application No. 60/328,789, filed on Oct. 15, 2001.

(30) Foreign Application Priority Data
Oct. 10, 2001 (JP) P2001-312474
Nov. 1, 2001 (JP) P2001-336390

(51) Int. Cl. C01F 7/22; C08K 3/18; C08K 9/06

(52) U.S. Cl. 523/212; 423/625; 524/430

(57) ABSTRACT

The present invention provides particulate alumina having a mean particle size corresponding to a volume-cumulative (50%) mean particle size (D50) of 1.5 to 4 μm and a ratio (D90/D1O) of D90 to D10 of 2.5 or less. The alumina contains secondary particles having a particle size of at least 10 μm in an amount of 0.1 mass % or less; secondary particles having a particle size of 0.5 μm or less in an amount of 5 mass % or less; and an α-phase as a predominant phase.fluoride. The present invention also provides a method for producing the particulate alumina.

### CROSS-REFERENCE TO RELATED APPLICATIONS

This application claims benefit of Provisional Application 60/328,789 filed Oct. 15, 2001, incorporated herein by reference, under 35 U.S.C. § 111(b), pursuant to 35 U.S.C. § 119(e)(1).

### BACKGROUND OF THE INVENTION

1. Field of the Invention

The present invention relates to particulate alumina and to an industrial, economical method for producing particulate alumina which is particularly useful for materials such as sealing material for electronic parts; fillers; finish lapping material; and aggregates incorporated into refractory, glass, ceramic, or composite material thereof and which causes little wear and exhibits excellent flow characteristics. The invention also relates to particulate alumina produced through the method and to a composition containing the particulate alumina.

2. Background Art

In recent years, demands for higher integration and higher density of electronic parts have elevated electric power consumption per chip. Thus, effective removal of generated heat in order to suppress temperature elevation of electronic elements is a critical issue. In view of the foregoing, alumina, particularly corundum (α-alumina), exhibiting excellent thermal conductivity, has become a candidate filler for a heat-dissipation spacer; a substrate material on which insulating sealing materials for semiconductors and parts of semiconductor devices are mounted; etc., and modification of alumina has been effected in a variety of fields.

Among such corundum particles, Japanese Patent Application Laid-Open (kokai) No. 5-294613 discloses spherical corundum particles having no fractures and a mean particle size of 5 to 35 μm, the particles being produced by adding aluminum hydroxide and optional, known agents serving as crystallization promoters in combination to a pulverized product of alumina such as electrofused alumina or sintered alumina, and firing the mixture.

The above publication also discloses that roundish corundum particles having a mean particle size of 5 μm or less can be produced through a known method including addition of a crystal growth agent to aluminum hydroxide.

Specifically, Japanese Patent Application Laid-Open (kokai) No. 5-43224 discloses that spherical alumina particles can be produced by heating aluminum hydroxide at 700° C. or lower to sufficiently cause dehydration and pyrolysis; elevating the temperature of the resultant heated product to yield a f ire intermediate having an a ratio of 90% or higher; and firing the fire intermediate in the presence of a fluorine-containing hardening agent.

There has also been known a thermal spraying method in which alumina produced through the Bayer method is jelted into high-temperature plasma or oxygen-hydrogen flame, to thereby produce roundish crystal particles through melting and quenching. However, the thermal spraying method has a drawback that unit heat energy requirement is large, resulting in high costs. In addition, the thus-produced alumina, although predominantly containing α-alumina, includes by-products such as δ-alumina. Such an alumina product is not preferred, since the product lowers thermal conductivity.

Pulverized products of electrofused alumina or sintered alumina have also been known as corundum particles. However, these corundum particles are of indefinite shape having sharp fractures and produce significant wear in a kneader, a mold, etc. during incorporation thereof into rubber/plastic. Thus, these corundum particles are not preferred.

Meanwhile, insulating film formed of a high-thermal-conductivity rubber/plastic composition, typically used in an MC substrate (metal core substrate) which is employed in, among others, automobiles, becomes thinner and thinner. In some cases, the film must be thinned to a thickness of 30 μm or less. In order to attain such a small thickness, roundish alumina particles must have a smaller particle size and exhibit a narrow particle size distribution profile.

However, since the smaller the particle size, the higher the cohesion force, fluidity is deteriorated upon incorporation of microparticles into rubber/plastic, and the microparticles form agglomerated particles in the resultant rubber/plastic composition, possibly lowering thermal conductivity. Thus, a limitation is also imposed on the decrease in particle size of microparticles.

The particulate alumina disclosed in Japanese Patent Application Laid-Open (kokai) No. 6-191833 has a shape for suitably serving as a filler for a rubber/plastic composition. However, since the above particulate alumina is produced through a special process called in-situ CVD, the production cost thereof is considerably high as compared with particulate alumina produced through other methods, resulting in a disadvantage in terms of economy. In addition, the above particulate alumina has a drawback in its characteristics; i.e., broad particle size distribution profile.

The particulate alumina disclosed in the aforementioned Japanese Patent Application Laid-Open (kokat) No. 5-294613 has an excessively large particle size, and the particulate alumina disclosed in Japanese Patent Application Laid-Open (kokai) No. 5-43224 has a drawback in that particles thereof strongly agglomerated, to thereby broaden the particle size distribution profile of the crushed product.

### BRIEF SUMMARY OF THE INVENTION

The present inventors have carried out extensive studies in order to overcome the aforementioned drawbacks, and have found that the drawbacks can be removed through employment of particulate alumina exhibiting the following characteristics and have also found a method for effectively producing the particulate alumina exhibiting the characteristics. The present invention has been accomplished on the basis of these findings.

Thus, an object of the present invention is to provide particulate alumina suitable for a filler added to high-thermal-conductivity composition.

Another object of the invention is to provide a method for producing the particulate alumina.

Still another object of the invention is to provide a composition containing the particulate alumina.

Accordingly, in one aspect of the present invention, there is provided particulate alumina having a mean secondary particle size corresponding to a 50% volume cumulative as determined from the secondary particle size distribution curve (hereinafter simply referred to as “a volume-cumulative (50%) mean particle size (D50)”) of 1.5 to 4 μm; having a ratio (D90/D10) of D90 to D10 of 2.5 or less; and containing secondary particles having a particle size of at least 10 μm in an amount of 0.1 mass % or less,secondary particles having a particle size of 0.5 μm or less in an amount of 5 mass % or less; and an α-phase as a predominant phase.

Preferably, the particulate alumina has a ratio (DL/DS) of longer primary particle diameter (DL) to shorter primary particle diameter (DS) of 2 or less and a ratio (D50/DP) of D50 to mean primary particle size (DP) of 2.5 or less.

Preferably, the particulate alumina having an oil absorption of 15 cc or less.

In a second aspect of the present invention, there is provided a method for producing particulate alumina comprising the steps of adding a halide other than a fluoride to aluminum hydroxide; firing the resultant mixture in a sealed container; and subsequently, crushing the fired product.

Preferably, the aluminum hydroxide has a BET specific surface area of 3 m²/g to 20 m²/g and an SiO₂ content of 0.02% or less.

Preferably, the halide other than fluoride is at least one halide selected from the group consisting of hydrogen halide, ammonium halide, and aluminum halide.

Preferably, the halide other than fluoride is ammonium chloride.

Preferably, the halide other than fluoride is added in an amount of 2 to 10 mass % based on the amount of aluminum hydroxide.

Preferably, firing is performed at a temperature range of 1,000 to 1,5000° C. and for a maximum temperature retention time of 10 minutes to 10 hours.

Preferably, the sealed container includes a sagger formed of dense alumina or dense cordie rite.

Preferably, the sealed container is formed of a substance having a porosity of 5% or less.

Preferably, crushing is performed by ball mill employing alumina balls or an airflow pulverizer employing a nozzle jet gauge pressure of 3×10⁶ Pa or less.

In a third aspect of the invention, there is provided particulate alumina which by adding a halide other than fluoride to aluminum hydroxide; firing the resultant mixture in a sealed container; and subsequently crushing the fired product.

Preferably, the particulate alumina is surface-coated with a silane coupling agent and/or a compound having at least one group selected from among an amino group, a carboxyl group, and an epoxy group.

Preferably, the compound having at least one group selected from among an amino group, a carboxyl group, and an epoxy group is modified silicone oil.

Preferably, the particulate alumina is surface-coated with the silane coupling agent and/or the compound having at least one group selected from among an amino group, a carboxyl group, and an epoxy group in an amount of 0.05 mass % to 5 mass % based on the particulate alumina.

In a fourth aspect of the invention, there is provided a composition containing a polymer and particulate alumina as recited above.

Preferably, the polymer is at least one polymer selected from the group consisting of aliphatic resin, unsaturated polyester resin, acrylic resin, methacrylic resin, vinyl ester resin, epoxy resin, and silicone resin.

Preferably, the composition contains particulate alumina in an amount of at least 80 mass %.

Preferably, the polymer is an oily substance.

Preferably, the polymer has a softening point or a melting point of 40° C. to 100° C.

In a fifth aspect of the invention, there is provided a thermal conductive composition containing the composition as recited above.

In a sixth aspect of the invention, there is provided an electronic part or a semiconductor device containing the thermal conductive composition between a heat source and a radiator.

### DESCRIPTION OF THE INVENTION

The particulate alumina of the present invention has a volume-cumulative (50%) mean particle size (D50) of 1.5 to 4 μm; has a ratio (D90/D10) of D90 to D10 of 2.5 or less; contains secondary particles having a particle size of at least 10 μm in an amount of 0.1 mass % or less; contains secondary particles having a particle size of 0.5 μm or less in an amount of 5 mass % or less; and contains an α-phase as a predominant phase.

The term “D10” as used herein refers to the secondary particle size corresponding to 10% volume-cumulative secondary particle size as determined from a secondary particle size distribution curve and the term “D90” as used herein refers to the secondary particle size corresponding to 90% volume-cumulative secondary particle size as determined from a secondary particle size distribution curve is D90.

The phrase “contains an α-phase as a predominant phase” refers to the particulate alumina having an α-phase content of at least 95 mass %, preferably at least 98 mass %. The α-phase content is determined in the following manner.

X-ray diffractometry of particulate al umina is performed under the following conditions;

| | |
|---|---|
| Target | Cu · Kα |
| Slit | 0.3 mm |
| Scan speed | 2°/min |
| Scan range | 2θ = 10 to 70° |

α-Phase content is derived from the equation:

α-phase content=[(A−C)/((A−C)+(B−C))]×100, wherein A denotes a peak height (α-alumina) at 2φ=68.220, B denotes a peak height (K-alumina) at 2θ=63.10°, and C denotes a base line height at 2θ=69.5.

The volume-cumulative mean particle size of the present invention can be determined by means of any known particle size distribution on measuring apparatuses. For example, a laser diffraction particle size distribution measuring apparatus is preferably employed.

Such particulate alumina serves as alumina particles that are particularly suitable for a filler added to high-thermal-conductivity composition. D50 must fall within a range of 1.5 to 4 μm, and preferably falls within a range of 2 to 3 μm. When D50 is in excess of 4 μm, the high-thermal-conductivity composition is difficult to be processed into a layer having a thickness of 30 μm or less, whereas when D50 is less than 1.5 μm, alumina particles tend to be agglomerated in the high-thermal-conductivity composition.

(D90/D10) must be controlled to 2.5 or less, and is preferably 2 or less. When (D90/D10) is in excess of 2.5, the particle size distribution profile is broadened, thereby reducing thermal conductivity of the composition even when particulate alumina is added to the composition in a fixed amount.

When the amount of secondary particles having a particle size of at least 10 μm is higher than 0.1 mass %, a layer formed of the high-thermal-conductivity composition is difficult to form to a thickness of 30 μm or less. When the amount of secondary particles having a particle size of 0.5 μm or less is higher than 5 mass %, flowability of the composition is deteriorated.

The particulate alumina of the present invention preferably has a ratio (DL/DS) of longer primary particle diameter (DL) to shorter primary particle diameter (DS) of 2 or less and a ratio (D50/DP) of D50 to mean primary particle size (DP) of 2.5 or less, because such particulate alumina is suitable as a filler to be added to a high-thermal-conductivity composition.

When (DL/DS) is in excess of 2, the particle shape becomes flat, thereby deteriorating thermal conductivity of the composition. When (D50/DP) is in excess of 2.5, alumina particles are quasi-agglomerated, thereby deteriorating flowability of the composition.

In the present invention, the longer primary particle diameter (DL) and shorter primary particle diameter (DS) of alumina particles are determined through photographic analysis of secondary electron images observed under an SEM (scanning electron microscope).

The mean primary particle size (DP) is calculated from the BET specific surface area on the basis of the following equation:

Primary particle size (μm)=6/(true density of alumina×BET specific surface area (unit: m²/g)),

wherein the true density of alumina is 3.987 g/cm³, and the BET specific surface area is determined through the nitrogen adsorption method.

Preferably, the particulate alumina of the present invention exhibits an oil absorption of 15 cc or less. The term “oil absorption” refers to an amount of oil adsorbed by 100 g of particulate alumina. Specifically, the oil absorption is determined by adding linseed oil dropwise to 5 g of particulate alumina; measuring the amount of oil required until the particulate alumina forms a single mass; and converting the amount to the amount of oil adsorbed by 100 g of particulate alumina. When the oil absorption is in excess of 15 cc, flowability of the composition is deteriorated.

The particulate alumina of the present invention is produced through a process including the steps of adding, to an alumina source such as aluminum hydroxide, a halide other than a fluoride; firing the resultant mixture in a sealed container; and subsequently, crushing the fired product. Preferably, the aluminum hydroxide employed in the above process has a BET specific surface area of 3 m²/g to 20 m^{2/}g, and an SiO₂ content of 0.02% or less. More preferably, the BET specific surface area falls within a range of 4 m²/g to 10 m²/g. When the BET specific surface area is less than 3 m²/g, alumina particles are strongly agglomerated, whereas when the BET specific surface area is in excess of 20 m²/g, growth of alumina particles is inhibited. In addition, when the SiO₂ content is in excess of 0.02%, alumina particles tend to be plate-like and to be agglomerated strongly. Examples of the alumina hydroxide that can be used as the alumina source include gibbsite, bayerite, boehmite, diaspore, and dehydrated products thereof obtained by calcining in advance at approximately 400° C.

Preferably, the halide other than fluoride used in the present invention is at least one halide selected from the group consisting of hydrogen halide, ammonium halide, and aluminum halide, with ammonium chloride being more preferred.

According to the production method of the present invention, the halide other than fluoride Is preferably added, to a sealable container together with aluminum hydroxide, in an amount of 2 to 10 mass %, more preferably 3 mass % to 6 mass %, based on the amount of aluminum hydroxide. Even when the halide other than fluoride is added in an amount higher than 10 mass %, the effect of the present invention; i.e., provision of particulate alumina suitable as a filler adde d to a high-thermal-conductivity composition, is no longer enhanced. Such an excess amount is not preferred, from the viewpoint of economy. When the amount is less than 2 mass %, alumina particles are not grown, which is disadvantageous.

Preferably, in the present invention, the step of firing aluminum hydroxide and an added halide other than fluoride in a sealed container is performed at a temperature range of 1,000 to 1,500° C. and for a maximum temperature retention time of 10 minutes to 10 hours. More preferably, the firing temperature is controlled to 1,200° C. to 1,400° C., and the maximum temperature retention time is 30 minutes to 8 hours.

When the firing temperature is lower than 1,000° C., α-phase does not form in particulate alumina, which is not preferred, and when the maximum temperature retention time is shorter than 10 minutes, growth of alumina particles is inhibited, which is not preferred. Even when the firing temperature is in excess of 1,500° C. or the retention time is longer than 10 hours, the effect of the invention is no longer enhanced, which is not preferred, from the viewpoint of economy. No particular limitation is imposed on the type of the heating furnace employed for firing, and known means such as a single kiln, a tunnel kiln, and a rotary kiln may be employed.

The sealed container employed in the production method of the present invention preferably includes a sagger formed of dense alumina or dense cordierite. In addition, the sealed container is preferably formed of a substance having a porosity of 5% or less. The sealed container is not necessarily closed completely, and any sealed container can be used so long as the container has no opening. For example, the container may comprise a cylinder having a bottom and a lid. Preferably, the cylinder portion is tightly bonded with the bottom and the lid.

In the production method of the present invention comprising the steps of adding, to an alumina source such as aluminum hydroxide, a halide other than fluoride; firing the resultant mixture in a sealed container; and subsequenty, crushing the fired product, crushing is preferably performed by means of a ball mill employing alumina balls or by means of an airflow pulverizer employing a nozzle jet gage pressure (relative pressure) of 3×10⁶ Pa (3 kgf/cm²) or less. In this case, the alumina balls preferably have a size of 10 to 25 mmφ. When a ball mill is employed, crushing time, which depends on the scale and performance of the ball mill, typically is 30 to 120 minutes. When an airflow pulverizer is employed, flow of air, amounts of raw materials fed, and rotation rate of a classifier incorporated in the airflow pulverizer are appropriately ad justed such that the crushed particulate alumina exhibits a predetermined oil absorption. Through comparatively slight crushing as described above, the particulate alumina of the present invention suitably serving as a filler to be added to a high-thermal-conductivity composition can effectively be produced.

Preferably, the particulate alumina of the present invention is surface-coated with a silane coupling agent and/or a compound having at least one group selected from among an amino group, a carboxyl group, and an epoxy group.

By kneading the thus-surface-treated particulate alumina and a resin, the amount of the particulate alumina which can be added to the resin increases, as compared with the case of kneading non-surface-treated particulate alumina and a resin. In addition, even when the amount of particulate alumna added to a resin is increased, viscosity of the kneaded product is not highly elevated. Thus, softness of the composition is not prone to be deteriorated, leading to enhancement of mechanical characteristics of the composition such as wear resistance.

In the present invention, among compounds having at least one group selected from among an amino group, a carboxyl group, and an epoxy group, those readily adsorbing on or reacting with the surface of particulate alumina are preferred, and any known such compounds can be employed.

Examples of preferred ones among the above compounds include 1,2-epoxyhexane, 1,2-epoxydodecane, n-hexylamine, n-dodecylamine, p-n-hexylaniline, n-hexylcarboxylic acid, n-dodecylcarboxylic acid, and p-n-hexylbenzoic acid.

Examples of preferred modified silicone oils include KF-10, KF-101, KF-102, X-22-173DX, KF-393, KF-864, KF-8012, KF-857, X-22-3667, X-22-162A, and X-22-3701 E (product of product of Shin-Etsu Chemical Co., Ltd.); TSF4700, TSF4701, TSF4702, TSF4703, TSF4730*, and TSF4770 (product of GE Toshiba Silicone); and SF8417, BY16-828, BY16-849, BY16-892, BY16-853, BY16-837, SF8411, BY16-875, BY16-855, SF8421, SF8418, and BY16-874 (product of Toray Dow Corning Silicone). These oils may be used singly or in a combination of a plurality of such oils.

No particular limitation is imposed on the silane coupling agent, and any known compounds may be used so long as the compounds have on a silicon atom a hydrolyzable substituent such as a halogen atom or an alkoxy group. Examples of preferred silane coupling agents include vinyltrichlorosilane, vinyltrimethoxysilane, β-(3,4-epoxycyclohexyl)ethyltrimethoxysilane, γ-glycidoxypropyltriethoxysilane, γ-methacryloxypropyltrimethoxysilane, γ-aminopropyltriethoxysilane, N-phenyl-γ-aminopropyltrimethoxysilane, γ-chloropropyltrimethoxysilane, γ-mercaptopropyltrimethoxysilane, n-hexyltrimethoxysilane, n-octyltrimethoxysilane, n-dodecyltrimethoxysilane, phenyltriethoxysilane, diphenyidimethoxysilane, and hexamethyidisilazane. These silane coupling agents may be used singly or in a combination of a plurality of such coupling agents.

No particular limitation is imposed on the method for coating particulate alumina with any of these compounds, and any known method can be employed. Specific examples include dry treatment and wet treatment.

The amount of the coating agent (e.g., silane coupling agent) with which particulate alumina is coated preferably falls within a range of 0.05 mass % to 5 mass % based on particulate alumina. When the amount is less than 0.05 mass %, sufficient coating effect is difficult to attain, whereas when the amount is in excess of 5 mass %, the amount of unreacted coating agent (e.g., silane coupling agent) increases, to thereby yield residual unreacted coating agent, which is disadvantageous.

The particulate alumina produced through the production method of the present invention is preferably incorporated into polymers such as oil, rubber, and plastics, whereby a high-thermal-conductivity grease composition, a high-thermal-conductivity rubber composition, and a high-thermal-conductivity plastic composition are provided. The particulate alumina is particularly preferably contained in an amount of at least 80 mass %.

Any known polymers can be employed as a polymer for constituting the resin composition of the present invention. Examples of preferred polymers include aliphatic resin, unsaturated polyester resin, acrylic resin, methacrylic resin, vinyl ester resin, epoxy resin, and silicone resin.

These resins may have low molecular weight or high molecular weight, The form of these resins can be arbitrarily determined in accordance with purposes and circumstances of use, and may be oil-like liquid, rubber-like material, or hardened products.

Examples of the resins include hydrocarbon resins (e.g., polyethylene, ethylene-vinyl acetate copolymer, ethylene-acrylate copolymer, ethylene-propylene copolymer, poly(ethylene-propylene), polypropylene, polyisoprene, poly(isoprene-butylene), polybutadiene, poly(styrene-butadiene), poly(butadiene-acrylonitrile), polychloroprene, chlorinated polypropylene, polybutene, polyisobutylene, olefin resin, petroleum resin, styrol resin, ABS resin, coumarone-indene resin, terpene resin, and rosin resin, diene resin); (meth)acrylic resins (e.g., homopolymers and copolymers produced from methyl (meth)acrylate, ethyl (meth)acrylate, 2-ethylhexyl (meth)acrylate, n-nonyl (meth)acrylate, (meth)acrylic acid, and/or glycidyl (m eth)acrylate; polyacrylonitrile and copolymers thereof; polycyanoacrylate; polyacrylamide; and poly((meth)acrylic acid) salts); vinyl acetate resins and vinyl alcohol resins (e.g., vinyl acetate resin, polyvinyl alcohol, polyvinyl acetal resin, and polyvin yl ether); halogen-containing resins (e.g., vinyl chloride resin, vinylidene chloride resin, fluororesin); nitrogen-containing vinyl resins (e.g., poly(vinylcarbazole), poly(vinylpyrrolidone), poly(vinylpyridine), and poly(vinylimidazole)); diene polymers (e.g., butadiene-based synthetic rubber, chloroprene-based synthetic rubber, and isoprene-based synthetic rubber); polyethers (e.g., polyethylene glycol, polypropylene glycol, hydrin rubber, and Penton resin); polyethyleneimine resins; phenolic resins (e.g., phenol-formalin resin, cresol-formalin resin, modified phenolic resin, phenol-furfural resin, and resorcin resin); amino resins (e.g., urea resin and modified urea resin, melamine resin, guanamine resin, aniline resin, and sulfonamide resin); aromatic hydrocarbon resins (e.g., xylene-formaldehyde resin, toluene-formalin resin); ketone resins (e.g., cyclohexanone resin and methyl ethyl ketone resin); saturated alkyd resin; unsaturated polyester resins (e.g., maleic anhydride-ethylene glycol polycondensate and maleic anhydride-phthalic anhydride-ethylene glycol polycondensate); allyl phthalate resins (e.g., unsaturated polyester resin crosslinked with diallyl phthalate); vinyl ester resins (e.g., resin produced by crosslinking a primary polymer having a bis phenol A ether bond and highly reactive terminal acrylic double bonds with styrene, an acrylic ester, etc.); allyl ester resins; polycarbonates; polyphosphate ester resins; polyamide resins; polyimide resins; silicone resins (e.g., silicone oil, silicone rubber, and silicone resin derived from polydimethylsiloxane, and reactive silicone resin which has in its molecule a hydrosiloxane, hydroxysiloxane, alkoxysiloxane, or vinylsiloxane moiety and which is cured by heat or in the presence of a catalyst); furan resins; polyurethane resins; polyurethane rubbers; epoxy resins (e.g., bisphenol A epichlorohydrin condensate, novolak phenolic resin-epichlorohydrin condensate, polyglycol epichlorohydrin condensate); and phenoxy resins and modified products thereof. Th ese resins may be used singly or in combination of a plurality of species.

These polymers may have low molecular weight or high molecular weight. The form of these resins can be arbitrarily determined in accordance with purposes and circumstances of use, and may be oil-like liquid, rubber-like material, or hardened products.

Of these, unsaturated polyester resin, acrylic resin, methacrylic resin, vinyl ester resin, epoxy resin, and silicone resin are preferably used.

More preferably, the polymer is an oily substance, since a grease prepared by mixing particulate alumina and an oil conforms the surface configuration of a heat source and that of a radiator included in an electronic device and reduces the distance therebetween, thereby enhancing heat dissipation effect.

No particular limitation is imposed on the type of oil which can be used as the polymer into which the particulate al umina is incorporated, and any oil species can be employed. Examples include silicone oil, petroleum-based oil, synthetic oil, and fluorine-containing oil.

Preferably, in order to facilitate handling of the thermal conductive composition, the oil is a polymer which assumes a sheet-like shape at room temperature and becomes greasy when it is softened or melted as temperature elevates. No particular limitation is imposed on such a type of oil, and those known in the art can be employed. Examples include thermoplastic resins, low-molecular weight species thereof, and thermoplastic resin compositions whose softening point or melting point has been modified by blending an oil. The softening point or melting point, depending on the temperature of a heat source, preferably falls within a range of 40° C. to 100° C.

The aforementioned thermal conductive resin is inserted between a heat source of an electronic part or a semiconductor device and a radiator such as a radiation plate, thereby effectively dissipating generated heat, suppressing thermal deterioration and other types of deterioration of the electronic part or semiconductor device, reducing the incidence of maloperations, and prolonging the service life thereof. No particular limitation is imposed on the electronic parts and semiconductor devices, and examples include computer's CPUs (central processing units); PDPs (plasma displays); secondary batteries and relating apparatuses (e.g., an apparatus disposed in a hybrid electric vehicle or the like for stabilizing cell characteristics by controlling temperature through provision of the aforementioned thermal conductive composition between a secondary battery and a radiator; radiators for motors; Peltier's devices; inverters; and (high) power transistors.

### EXAMPLES

The present invention will next be described in detail by way of Examples and Comparative Examples, which should not be construed as limiting the invention thereto.

### Example 1

Ammonium chloride (5 mass %) was added to aluminum hydroxide (H-42M, product of Showa Denko K. K.) (1,500 g), and the resultant mixture was placed in a sealable container including a sagger formed of dense alumina and sealed. The container was of a cylindrical shape and had a bottom and a lid (outer diameter: 180 mmφ, inner diameter: 170 mmφ, height: 240 mm). The container had a porosity of approximately 0.5%.

The sealed container was heated at 1,250° C. for five hours, to thereby fire aluminum hydroxide. After cooling of the container, the fired product was removed from the container and lightly crushed by means of an airflow pulverizer at a nozzle jet gage pressure of 2×10⁶ Pa. Through X-ray diffractometry, the crushed particulate product was found to be alumina having an α-phase content of 95%. BET specific surface area of the thus-produced particulate alumina was determined through the nitrogen adsorption method. The volume-cumulative mean particle size and the particle size distribution of the particulate alumina were obtained by use of sodium hexametaphosphate serving as a dispersant and by means of a laser diffraction particle size distribution measuring apparatus (Microtrack HRA, product of Nikkiso). The longer and shorter particle sizes of the particulate alumina were determined from an SEM photograph. The primary particle size was calculated from the BET specific surface area on the basis of the aforementioned conversion equation.

### Examples 2 to 18. Comparative Examples 1 to 4

In each case, particulate alumina was produced under the conditions shown in Table 1. Other conditions not shown in Table 1 were the same as those employed in Example 1. Properties of aluminum hydroxide samples, employed as raw materials, are shown in Table 3.

Evaluation results of the thus-obtained particulate alumina products are shown in Tables 1 and 2. As shown in Table 1, the amount of hydrochloric acid, AlCl₃-6H₂O, AlF₄, or NH₄F added instead of ammonium chloride was reduced to the corresponding amount of ammonium chloride.

TABLE 1

| | Aluminum hydroxide | | | | | | | |
|---|---|---|---|---|---|---|---|---|
| | Material | | | | Firing | | | |
| | characteristics | | | | Amount of added NH₄Cl | Firing | Retention | |
| | BET value | SiO₂ | | Calcining | (mass %) | temp. | time | |
| | (m²/g) | (%) | Name | (400° C.) | based on Al hydroxide | (° C.) | (hr) | Firing container |
| Ex. 1 | 5 | 0.01 | H-42M | No | 5 | 1250 | 4 | Dense alumina |
| Ex. 2 | 7 | 0.01 | H-43M | No | 5 | 1250 | 4 | Dense alumina |
| Ex. 3 | 10 | 0.01 | H-43M | No | 5 | 1250 | 4 | Dense alumina |
| Ex. 4 | 15 | 0.02 | H-43M | No | 5 | 1250 | 4 | Dense alumina |
| Ex. 5 | 7 | 0.01 | H-43M | No | 3 | 1250 | 4 | Dense alumina |
| Ex. 6 | 7 | 0.01 | H-43M | No | 2 | 1250 | 4 | Dense alumina |
| Ex. 7 | 7 | 0.01 | H-43M | Yes | 5 | 1250 | 4 | Dense alumina |
| Ex. 8 | 7 | 0.01 | H-43M | No | 5(HCl) | 1250 | 4 | Dense alumina |
| Ex. 9 | 7 | 0.01 | H-43M | No | 5(AlCl₃.6H₂O) | 1250 | 4 | Dense alumina |
| Ex. 10 | 7 | 0.01 | H-43M | No | 5 | 1050 | 4 | Dense alumina |
| Ex. 11 | 7 | 0.01 | H-43M | No | 5 | 1050 | 4 | Dense cordierite |
| Ex. 12 | 7 | 0.01 | H-43M | No | 5 | 1200 | 10 min | Dense alumina |
| Ex. 13 | 7 | 0.01 | H-43M | No | 5 | 1375 | 4 | Dense alumina |
| Ex. 14 | 2 | 0.01 | H-32 | No | 5 | 1250 | 4 | Dense alumina |
| Ex. 15 | 22.5 | 0.02 | H-32 | No | 5 | 1250 | 4 | Dense alumina |
| Ex. 16 | 15.6 | 0.03 | H-32 | No | 5 | 1250 | 4 | Dense alumina |
| Ex. 17 | 7 | 0.01 | H-43M | No | 1 | 1250 | 4 | Dense alumina |
| Comp. Ex. 1 | 7 | 0.01 | H-43M | No | 5(AlF₃) | 1250 | 4 | Dense alumina |
| Comp. Ex. 2 | 7 | 0.01 | H-43M | No | 5(NH₄F) | 1250 | 4 | Dense alumina |
| Ex. 18 | 7 | 0.01 | H-43M | No | 5 | 1250 | 4 | Porous alumina |
| Comp. Ex. 3 | 7 | 0.01 | H-43M | No | 5 | 1250 | 4 | Porous cordierite |
| Comp. Ex. 4 | 7 | 0.01 | H-43M | No | — | 1250 | 4 | Dense alumina |

TABLE 2

| | Product characteristics | | | | | | | | | |
|---|---|---|---|---|---|---|---|---|---|---|
| | BET | | | | | Oil | | ≧10 μm | ≦0.5 μm | |
| | value | DP | D50 | | | absorption | Crystal | content | content | |
| | (m²/g) | (μm) | (μm) | D50/DP | D90/D10 | (cc) | morphology | (mass %) | (mass %) | DL/DS |
| Ex. 1 | 0.67 | 2.24 | 4.0 | 1.79 | 1.6 | 12.0 | Roundish | 0.02 | 1 | 1.5 |
| Ex. 2 | 0.98 | 1.54 | 3.2 | 2.08 | 1.8 | 12.0 | Roundish | 0.01 | 2 | 1.2 |
| Ex. 3 | 1.26 | 1.19 | 2.6 | 2.18 | 2.0 | 13.0 | Roundish | 0.03 | 2 | 1.5 |
| Ex. 4 | 1.71 | 0.88 | 1.8 | 2.04 | 2.1 | 13.5 | Roundish | 0.02 | 3 | 1.0 |
| Ex. 5 | 1.04 | 1.45 | 3.0 | 2.07 | 1.9 | 12.5 | Roundish | 0.02 | 2 | 1.3 |
| Ex. 8 | 1.96 | 0.77 | 1.5 | 1.95 | 2.3 | 14.0 | Roundish | 0.04 | 4 | 1.2 |
| Ex. 7 | 1.30 | 1.16 | 2.5 | 2.16 | 2.0 | 13.0 | Roundish | 0.02 | 2 | 1.4 |
| Ex. 8 | 1.33 | 1.13 | 2.4 | 2.12 | 2.0 | 13.0 | Roundish | 0.02 | 2 | 1.5 |
| Ex. 9 | 1.33 | 1.13 | 2.2 | 1.94 | 1.8 | 12.5 | Roundish | 0.02 | 2 | 1.6 |
| Ex. 10 | 1.01 | 1.49 | 3.2 | 2.14 | 2.1 | 13.0 | Roundish | 0.03 | 2 | 1.4 |
| Ex. 11 | 1.12 | 1.34 | 3.0 | 2.23 | 2.2 | 13.0 | Roundish | 0.02 | 2 | 1.6 |
| Ex. 12 | 0.95 | 1.58 | 3.4 | 2.15 | 1.8 | 13.0 | Roundish | 0.02 | 1 | 1.3 |
| Ex. 13 | 0.91 | 1.65 | 3.6 | 2.18 | 1.9 | 12.0 | Roundish | 0.01 | 2 | 1.5 |
| Ex. 14 | 0.94 | 1.60 | 4.8 | 2.99 | 3.3 | 14 | Plate-like | 3 | 2 | 3.5 |
| Ex. 15 | 12.22 | 0.12 | 1.2 | 9.75 | 4.5 | 30 | Amorphous | 0.1 | 12 | — |
| Ex. 16 | 1.01 | 1.49 | 3.5 | 2.34 | 4.0 | 14 | Plate-like in | 1 | 4 | 2.5 |
| | | | | | | | some portions | | | |
| Ex. 17 | 7.14 | 0.21 | 1.0 | 4.74 | 4.0 | 25 | Amorphous | 0.1 | 15 | — |
| Comp. Ex. 1 | 3.57 | 0.42 | 3.0 | 7.12 | 3.5 | 18 | Flaky | 0.5 | 3 | 5 |
| Comp. Ex. 2 | 1.01 | 1.49 | 4.0 | 2.68 | 3.3 | 14 | Flaky | 2 | 2 | 5 |
| Ex. 18 | 5.95 | 0.25 | 1.2 | 4.74 | 4.0 | 20 | Amorphous | 0.05 | 10 | — |
| Comp. Ex. 3 | 6.76 | 0.22 | 1.2 | 5.39 | 4.2 | 22 | Amorphous | 0.05 | 10 | — |
| Comp. Ex. 4 | 7.60 | 0.20 | 1.0 | 5.05 | 3.8 | 25 | Amorphous | 0.05 | 14 | — |

TABLE 3

| | H-42M | H-43M | H-32 |
|---|---|---|---|
| Water absorption | 0.23 (mass %) | 0.30 (mass %) | 0.20 (mass %) |
| Al(OH)₃ | 99.6 | 99.6 | 99.8 |
| Fe₂O₃ | 0.01 | 0.01 | 0.01 |
| SiO₂ | 0.01 | 0.01 | 0.01 |
| Na₂O | 0.33 | 0.34 | 0.17 |
| w-Na₂O | 0.05 | 0.07 | 0.02 |

### Example 19

A solution obtained by mixing n-hexyltrimethoxysilane (1 part by mass) serving as a surface-treating agent, water (2 parts by mass), and methanol (18 parts by mass) was added by spraying over approximately 30 minutes to particulate alumina (100 parts by mass) obtained in Example 1, while particulate alumina was stirred by means of a Henschel mixer. The resultant mixture was further stirred for about 20 hours.

To the thus-surface-treated particulate alumina, silicone oil (KF96-100, product of Shin-Etsu Chemical Co., Ltd.) was added, and the resultant mixture was stirred by means of a planetary stirring-defoaming apparatus (KK-100, product of Kurabo Industries Ltd.). The ratio of particulate alumina to silicone oil was varied, to thereby determine a range of the ratio where particulate alumina and silicone oil can be homogeneously mixed. Table 4 shows the results. In Table 4, “O” denotes successful attainment of homogeneous mixing, and “X” denotes failure to attain homogeneous mixing.

### Example 20

The procedure of Example 19 was repeated, except that X-22-173DX (0.5 parts by mass) serving as a surface-treating agent and hexane (20 parts by mass) were used, to thereby determine a range of the ratio where two components can be homogeneously mixed. The results are also shown in Table 4.

### Comparative Example 5

The procedure of Example 20 was repeated, except that no surface-treating agent was used, to thereby determine a range of the ratio where two components can be homogeneously mixed. The results are also shown in Table 4.

Through surface treatment, the amount of the particulate atumina of the present invention which can be added to a resin increases, and the resultant composition exhibits high thermal conductivity, as compared with the case of non-surface-treated particulate alumina.

TABLE 4

| | 82 parts by | 84 parts by | 86 parts by | 88 parts by | 90 parts by |
|---|---|---|---|---|---|
| Filler ratio | mass | mass | mass | mass | mass |
| Ex. 19 | ◯ | ◯ | ◯ | ◯ | X |
| Ex. 20 | ◯ | ◯ | ◯ | ◯ | X |
| Comp. Ex. 5 | ◯ | ◯ | X | X | X |

### Example 21

To the particulate alumina (80 parts by mass) produced in Example 1, silicone oil (KF96-100, product of Shin-Etsu Chemical Co., Ltd.) (20 parts by mass) was added, and the resultant mixture was stirred by means of a planetary stirring-defoaming apparatus (KK-100, product of Kurabo Industries Ltd.), to thereby yield a grease. Thermal resistance of the thus-yielded grease was determined by use of an apparatus fabricated in accordance with ASTM (American Society for Testing and Materials) D5470. The results are shown in Table 5,

### Example 22

The procedure of Example 21 was repeated, except that silicone oil (KF96-100, product of Shin-Etsu Chemical Co., Ltd.) (20 parts by mass) was added to the particulate alumina (80 parts by mass) produced in Example 2, to thereby yield a grease and determine thermal resistance of the grease. The results are shown in Table 5.

### Example 23

The procedure of Example 21 was repeated, except that silicone oil (KF96-100, product of Shin-Etsu Chemical Co., Ltd.) (20 parts by mass) was added to the particulate alumina (80 parts by mass) produced in Example 3, to thereby yield a grease and determine thermal resistance of the grease. The results are shown in Table 5.

### Comparative Example 6

The procedure of Example 21 was repeated, except that silicone oil (KF96-100, product of Shin-Etsu Chemical Co., Ltd.) (20 parts by mass) was added to the particulate alumina (80 parts by mass) produced in Comparative Example 4, to thereby yield a grease and determine thermal resistance of the grease. The results are shown in Table 5.

TABLE 5

| | Ex. 21 | Ex. 22 | Ex. 23 | Comp. Ex. 6 |
|---|---|---|---|---|
| Thermal | 0.15 | 0.10 | 0.06 | 0.41 |
| resistance | | | | |
| (K · cm²/W) | | | | |

Measured at 35° C. (constant), 0.7 MPa

As described hereinabove, the particulate alumina of the present invention can be added to a resin in increased amounts, thereby providing a resin composition of high thermal conductivity at low cost. Particularly, rubber-based, plastic-based, and silicone oil-based resin compositions containing the particulate alumina of the present invention exhibit high thermal conductivity. When the composition of the present invention is provided between a heat source and a radiator Included in an electronic part or a semiconductor device, there can be attained excellent performance (i.e., higher operational speed and higher resistance to load) as compared with those of conventional electronic parts and semiconductor devices.

While the invention has been described in detail and with reference to specific embodiments thereof, it will be apparent to one skilled in the art that various changes and modifications can be made therein without departing from the spirit and scope thereof.

What is claimed is:

1. Particulate alumina having a mean particle size corresponding to a volume-cumulative (50%) mean particle size (D50) of 1.5 to 4 μm; having a ratio (D90/D10) of D90 to D10 of 2.5 or less; and containing secondary particles having a particle size of at least 10 μm in an amount of 0.1 mass % or less, secondary particles having a particle size of 0.5 μm or less in an amount of 5 mass % or less; and an α-phase as a predominant phase.

2. The particulate alumina according to claim 1, which has a ratio of longer primary particle diameter (DL) to shorter primary particle diameter (DS) of 2 or less and a ratio of D50 to mean primary particle size (DP) of 2.5 or less.

3. Particulate alumina according to claim 1, having an oil absorption of 15 cc or less.

4. A method for producing particulate alumina comprising the steps of addinga halide other than a fluoride to aluminum hydroxidefluoride; firing the resultant mixture in a sealed container; and subsequently, crushing the fired product.

5. The method for producing particulate alumina according to claim 4, wherein the aluminum hydroxide has a BET specific surface area of 3 m²/g to 20 m²/g and an SiO₂ content of 0.02% or less.

6. The method for producing particulate alumina according to claim 4, wherein the halide other than fluoride is at least one halide selected from the group consisting of hydrogen halide, ammonium halide, and aluminum halide.

7. The method for producing particulate alumina according to claim 4, wherein the halide other than fluoride is ammonium chloride.

8. The method for producing particulate alumina according to claim 4, wherein the halide other than fluoride is added in an amount of 2 to 10 mass % based on the amount of aluminum hydroxide.

9. The method for producing particulate alumina according to claim 4, wherein firing is performed at a temperature of 1,000 to 1,500° C. and for a maximum temperature retention time of 10 minutes to 10 hours.

10. The method for producing particulate alumina according to claim 4, wherein the sealed container includes a sagger formed of dense alumina or dense cordierite.

11. The method for producing particulate alumina according to claim 4, wherein the sealed container is formed of a substance having a porosity of 5% or less.

12. The method for producing particulate alumina according to claim 4, wherein crushing is performed by a ball mill employing alumina balls or an airflow pulverizer employing a nozzle jet gauge pressure of 3×10⁶ Pa or less.

13. Particulate alumina which is produced by adding a halide other than fluoride to aluminum hydroxide; firing the resultant mixture in a sealed container; and subsequently, crushing the fired product.

14. Particulate alumina as described in claim 1, wherein said alumina is surface-coated with a silane coupling agent and/or a compound having at leas t one group selected from the group consisting of an amino group, a carboxyl group, and an epoxy group.

15. Particulate alumina according to claim 14, wherein the compound having at least one group selected from the group consisting of an amino group, a carboxyl group, and an epoxy group is modified silicone oil.

16. Particulate alumina as described in claim 14, wherein said alumina is surface-coated with the silane coupling agent and/or the a compound having at least one group selected from the group consisting of an amino group, a carboxyl group, and an epoxy group in an amount of 0.05 mass % to 5 mass % based on the particulate alumina.

17. A composition comprising a polymer and particulate alumina as recited in claim 1.

18. The composition according to claim 17, wherein the polymer is at least one polymer selected from the group consisting of aliphatic resin, unsaturated polyester resin, acrylic resin, methacrylic resin, vinyl ester resin, epoxy resin, and silicone resin.

19. The composition according to claim 17, wherein said particulate alumina is present in an amount of at least 80 mass %.

20. The composition according to claim 17, wherein the polymer is an oily substance.

21. The composition according to claim 17, wherein the polymer has a softening point or a melting point of 40° C. to 100° C.

22. A thermal conductive composition comprising a composition according to claim 17.

23. An electronic part or a semiconductor device comprising a thermal conductive composition according to claim 22 between a heat source and a radiator.
